(19) United States
(12) Patent Application Publication
(10) Pub. No.: US 2008/0266400 A1
(43) Pub. Date: Oct. 30, 2008

(54) Testing system and testing method

(75) Inventors: Shen-Feng Lu, Hsinchu (TW); Shih-Ming Chen, Kaohsiung (TW); Hsing-Fu Huang, Hsinchu (TW)

Correspondence Address: Joe McKinney Muncy, PO Box 1364, Fairfax, VA, 22038-1364, US

(73) Assignee: VisEra Technologies Company Limited

(21) Appl. No.: 11/822,837

(22) Filed: Jul. 10, 2007

(30) Foreign Application Priority Data
Apr. 26, 2007 (TW) 096114748

(51) Int. Cl. H04N 17/02; H04N 5/225; H04N 5/335; H04N 9/68; H04N 17/00

(52) U.S. Cl. 348/187; 348/234; 348/311; 348/333.02; 348/E09.053; 348/E05.091; 348/E05.024

(57) ABSTRACT

A testing system including an image sensor, a transformer, and a display device is disclosed. The image sensor generates an image signal according to a light source. The transformer transforms the image signal into a processing signal. The display device displays a frame according to the processing signal.

### BACKGROUND OF THE INVENTION

1. Field of the Invention

The invention relates to a testing system, and more particularly to a testing system comprising an image sensor.

2. Description of the Related Art

With integrated circuit (IC) technology development, size of electronic products is reduced such that portability of electronic products is greatly increased. For detecting images, image sensors are built-in a majority of electronic products. Generally, image sensors comprise charge coupled devices (CCDs) and complementary metal oxide semiconductor (CMOS) image sensors.

One CCD comprises a plurality of photo sensors for detecting light and transforming the light into electronic signals. A conversion chip is utilized to transform the electronic signals into digital signals. Each photo sensor is called a pixel. A pixel is composed of a semiconductor material. The sensor ability of the semiconductor material is high. A CMOS image sensor transforms light into energy. An analog to digital converter (ADC) is utilized for transforming analog signals into digital signals.

A CMOS image sensor is manufactured by CMOS procedures. CMOS manufacturing procedures are P-channel metal-oxide-semiconductor field effect transistor (PMOSFET) and N-channel MOSFET (NMOSFET). Since characteristics of PMOSFET and NMOSFET are complementary, PMOSFET and NMOSFET are called CMOS. Only when PMOSFET or NMOSFET is operational, the CMOS consumes power, thus, CMOS image sensors manufactured by CMOS procedures conserve power and does not easily heat.

When CCD or CMOS is packaged, testing steps are required to test the CCD or CMOS. A tester discovers abnormal image sensors and then packages normal image sensors. If the tester does not accurately discover the abnormal image sensors, failure rate of image sensors is high.

### BRIEF SUMMARY OF THE INVENTION

Testing systems are provided. An exemplary embodiment of a testing system comprises an image sensor, a transformer, and a display device. The image sensor generates an image signal according to a light source. The transformer transforms the image signal into a processing signal. The display device displays a frame according to the processing signal.

Testing methods are provided. An exemplary embodiment of a testing method for a testing system is described in the following. The testing system comprises an image sensor, a transformer, and a display device. A light source is provided to the image sensor. An image signal generated by the image sensor is received. The image signal transforms into a processing signal. A frame is displayed according to the processing signal.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1 is a schematic diagram of an exemplary embodiment of a testing system;

FIG. 2 is a schematic diagram of another exemplary embodiment of a testing system;

FIG. 3 is a flowchart of an exemplary embodiment of a testing method; and

FIG. 4 is a flowchart of another exemplary embodiment of the testing method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

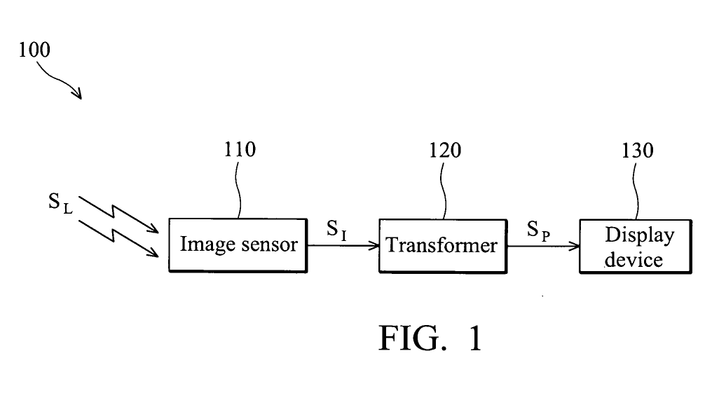

FIG. 1 is a schematic diagram of an exemplary embodiment of a testing system. Testing system 100 comprises an image sensor 110, a transformer 120, and a display device 130. Image sensor 110 generates an image signal S_{I} according to light source S_{L}. Transformer 120 transforms the image signal S_{I} into a processing signal S_{P}. Display device 130 displays a frame according to processing signal S_{P}.

Image sensor 110 is a CCD or a CMOS image sensor. The CCD or the CMOS image sensor detects light source S_{L} to generate image signal S_{I}. The format of image signal S_{I} is RGB format. Transformer 120 transforms the image signal comprising the RGB format into processing signal S_{P}. The format of processing signal S_{P} is a YUV format. Display device 130 displays a frame corresponding to the processing signal S_{P} comprising a YUV format. In this embodiment, transformer 120 is a digital signal processor (DSP) for transforming the format of image signal S_{I} from the RGB format into the YUV format. The principle of transforming the RGB format into the YUV format is well known to those skilled in the field, thus, description hereof is omitted.

A tester determines whether pixels of image sensor 110 are normal according to the frame. If a pixel of image sensor 110 is normal, the pixel detects light and provides the normal detecting result such that display device 130 displays the normal frame. When one pixel of image sensor 110 is abnormal, the abnormal pixel provides the error detecting result. Thus, a dark point or a shadow occurs in the frame. The tester determines the location of the abnormal pixel according to the location of the dark point or the shadow. The display device 130 displays the frame according to processing signal S_{P}. Since the YUV format emphasizes the image brightness, if the pixel of image sensor 110 is abnormal, the dark point or the shadow generated is obvious. Thus, the tester immediately determines the location of the abnormal pixel according to the dark point or the shadow.

Oppositely, if display device 130 displays the frame according to image signal S_{I}. Since the format of image signal S_{I} is the RGB format, the abnormal event is non-obvious, thus, the tester hardly ever discovers abnormal pixels. However, if the format of processing signal S_{P} is the YUV format, the tester will quickly be able to discover the abnormal pixel when display device 130 displays the frame according to processing signal S_{P}.

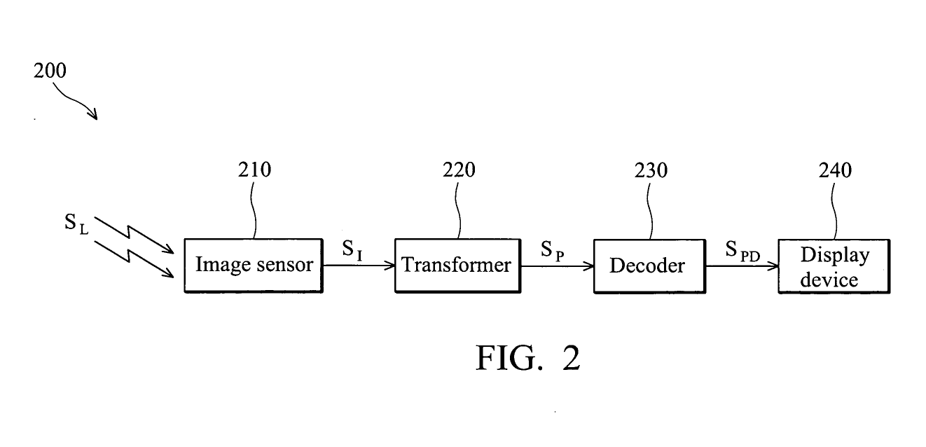

FIG. 2 is a schematic diagram of another exemplary embodiment of a testing system. Testing system 200 comprises an image sensor 210, a transformer 220, a decoder 230, and a display device 240. Image sensor 210 generates an image signal S_{I} according to light source S_{L}. Transformer 220 transforms the image signal S_{I} into a processing signal S_{P}. Decoder 230 decodes processing signal S_{P} to generate a decoded signal S_{PD}. Display device 240 displays a frame according to decoded signal S_{PD}. Since the operations of image sensors 110 and 210 are the same, description of image sensor 210 is omitted for brevity. Since the operations of transformers 120 and 220 are the same, description of transformer 220 is omitted. Since the operations of display devices 130 and 240 are the same, descriptions of display device 240 is omitted for brevity.

In this embodiment, since processing signal S_{P} is a low voltage differential signaling (LVDS), decoder 230 is utilized to execute a decoding action, thus, display device 240 immediately displays the frame. Since the format of processing signal S_{P} is the YUV format, the format of decoded signal S_{PD} is also the YUV format. Thus, display device 240 is in accordance with the YUV format to display the frame. Additionally, processing signal S_{P} is processed by decoder 230. When image sensor 210 is packaged and in a testing stage, the testing step relating to LVDS are omitted. In some embodiments, transformer 220 and decoder 230 are disposed on the same printed circuit board (PCB).

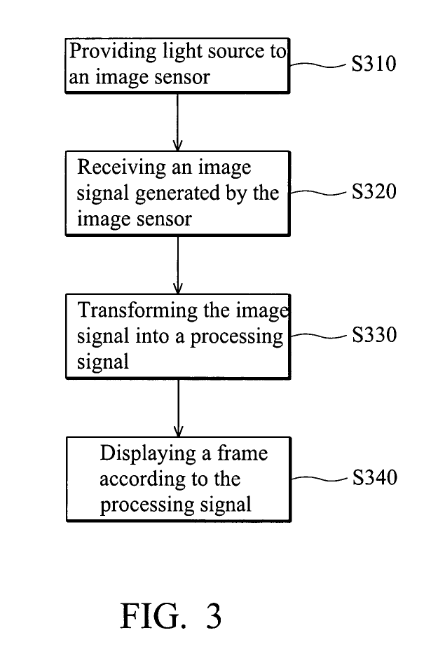

FIG. 3 is a flowchart of an exemplary embodiment of a testing method. The testing method is applied to testing system 100 shown in FIG. 1. A light source is provided to an image sensor (step S310). Referring to FIG. 1, image sensor 110 is a CCD or a CMOS image sensor for detecting light source S_{L}. Next, an image signal generated by the image sensor is received (step S320). When image sensor 110 detects light source S_{L}, image signal S_{I} is generated.

The image signal is transformed into a processing signal (step S330). Since the format of image signal S_{I} is the RGB format, the format of image signal S_{I} is transformed from the RGB format into the YUV format. Thus, processing signal S_{P} comprises the YUV format. A frame is displayed according to the processing signal (step S340). When display device 130 displays the frame according to processing signal S_{P}, a tester easily determines the location of abnormal pixels, thus, testing time is reduced.

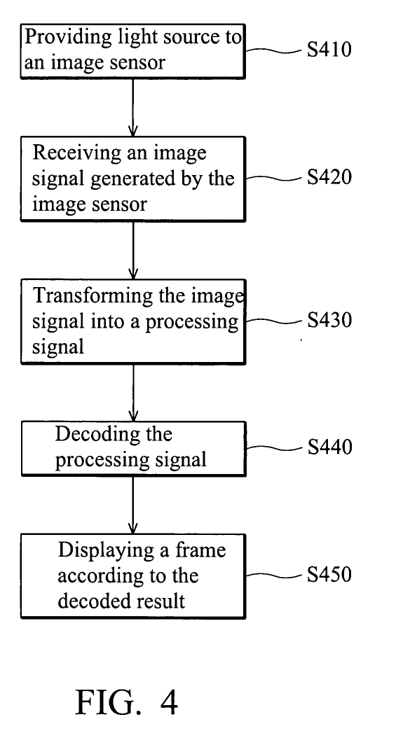

FIG. 4 is a flowchart of another exemplary embodiment of the testing method. The testing method is applied to testing system 200 shown in FIG. 2. A light source is provided to an image sensor (step S410). Next, an image signal generated by the image sensor is received (step S420). When image sensor 210 detects light source S_{L}, image signal S_{I} is generated.

The image signal is transformed into a processing signal (step S430). The format of image signal S_{I} is the RGB format. In this embodiment, the format of image signal S_{I} is transformed from the RGB format to the YUV format such that processing signal S_{P} is generated. The processing signal is decoded (step S440). When processing signal S_{P} is LVDS, a decoding step is required for immediately processing or receiving processing signal S_{P}.

A frame is displayed according to the processing signal (step S440). In this embodiment, display device 240 displays the frame corresponding to the decoded signal S_{PD}. Since decoder 230 generates decoded signal S_{PD} according to processing signal S_{P}, display device 240 indirectly bases frame display on processing signal S_{P}. The format of processing signal S_{P} is the YUV format, as such the format of decoded signal S_{PD} is the YUV format. Thus, display device 240 displays the frame according to the YUV format such that the tester easily determines the location of abnormal pixels according to the frame.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A testing system, comprising:
an image sensor generating an image signal according to a light source;
a transformer transforming the image signal into a processing signal; and
a display device displaying a frame according to the processing signal.

2. The testing system as claimed in claim 1, wherein the image signal comprises a RGB format and the processing signal comprises a YUV format.

3. The testing system as claimed in claim 2, wherein the processing signal is a low voltage differential signaling (LVDS).

4. The testing system as claimed in claim 3, further comprising a decoder coupled between the transformer and the display device for decoding the processing signal.

5. The testing system as claimed in claim 4, wherein the transformer and the decoder are disposed on the same printed circuit board (PCB).

6. The testing system as claimed in claim 5, wherein the transformer is a digital signal processor (DSP).

7. The testing system as claimed in claim 1, wherein the image sensor is a charge coupled device (CCD) or a complementary metal oxide semiconductor (CMOS) image sensor.

8. A testing method for a testing system comprising an image sensor, a transformer, and a display device, the testing method comprising:
providing a light source to the image sensor;
receiving an image signal generated by the image sensor;
transforming the image signal into a processing signal; and
displaying a frame according to the processing signal.

9. The testing method as claimed in claim 8, wherein the image signal is transformed from a RGB format into a YUV format.

10. The testing method as claimed in claim 9, further comprising decoding the processing signal such that the decoded result is displayed by the display device.
